(19) United States
(12) Patent Application Publication
(10) Pub. No.: US 2015/0338259 A1
(43) Pub. Date: Nov. 26, 2015

(54) MEASURING CONTAINERS

(71) Applicant: Fox Run USA, LLC, Ivyland, PA (US)

(72) Inventor: Rodney W. Robbins, Florence, AL (US)

(21) Appl. No.: 14/718,052

(22) Filed: May 20, 2015

Related U.S. Application Data
(60) Provisional application No. 62/001,223, filed on May 21, 2014.

(51) Int. Cl. G01F 19/00

(52) U.S. Cl. CPC G01F 19/002

(57) ABSTRACT

A wet and dry measurement spoon set wherein each spoon is adapted to include a bowl for measuring dry material at one end of the spoon and a bowl for measuring wet material at another end of the spoon. A series of spoons, each adapted to measure different volumes of material, are provided in a set wherein each spoon in the set is magnetically connected to another spoon in the set. The wet material bowl is adapted to include a ring that contrasts in color with the remainder of the bowl so as to clearly demark the fill-line for the bowl. A short wall extends above the wet material bowl in order to contain any fluids that overflow from the intended ring demarcation, so as to prevent the fluid from spilling or overflowing.

### CROSS REFERENCE TO RELATED APPLICATION(S)

This application claims the benefit of U.S. Provisional Application No. 62/001,223, filed on May 21, 2014.

### FIELD OF THE INVENTION

The present invention relates in general to measuring containers and, more specifically, to measuring spoons adapted for both fluid and dry material.

### BACKGROUND OF THE INVENTION

In liquid measuring containers, such as liquid measuring spoons, a common, long-standing problem is measuring the liquid in a manner such that the liquid does not overflow the measuring container and spill out.

It is and long has been a problem to provide measuring spoons of variable volume, for both dry measure materials and liquids.

Accordingly, a need exists in art to provide a liquid measuring container, such as a measuring spoon, in which it is relatively easy to see that the measuring capacity for liquid has been reached, and which protects against spillage.

It is a further need in the art to provide a set of measurement spoons of different volumes, having the advantageous features described above.

It is a further need in the art to combine dry measure and wet measure spoons, either individually or in sets having graduated measuring volumes.

It is a further need in the art to have such a device which is relatively economical to manufacture and simple to make and use.

### SUMMARY OF THE INVENTION

According to the present invention, the foregoing and other objects and advantages are obtained by the provision of a liquid measurement spoon which has a ledge extending circumferentially outwardly at a position near the top of the bowl of the container. The ledge has a horizontal portion which is of an appearance contrasting with that of the remainder of the measurement device so that the user can easily look downwardly at the container with liquid in it and see whether the liquid level has reached the ledge so that the user can tell easily when to stop filling the container with liquid. Further, such a device is preferably provided with an upward extension from the outer reaches of the ledge to contain a liquid flowing over the top level of the ledge and further preventing spillage, as well as preventing grossly inaccurate measurements.

According to another aspect of the invention, a set of measurement spoons is provided, each spoon having a dry measurement end and a liquid measurement end with the features described above. According to another aspect of the invention, the dry/wet measure spoons preferably are provided in a set of graduated spoons which are held together for compact storage when not in use.

The foregoing and other objects and advantages of the invention will be set forth in or apparent from the following description and drawings.

### BRIEF DESCRIPTION OF THE DRAWINGS

The invention will become more readily apparent from the following description of preferred embodiments thereof shown, by way of example only, in the accompanying drawings wherein:

FIG. 1 is a perspective view of a wet/dry measuring spoon set of the present invention;

FIG. 2 is a perspective view, partially exploded, showing the underside of one of the spoons of FIG. 1, with a magnetic insert for holding a group of spoons together to form a set;

FIG. 3 is a further perspective view of the liquid measurement end of one of the spoons shown in FIGS. 1 and 2;

FIG. 4 is a cross-sectional view of the spoon portion shown in FIG. 3; and

FIG. 5 is a top plan view of the structure shown in FIG. 4.

### DETAILED DESCRIPTION OF THE INVENTION

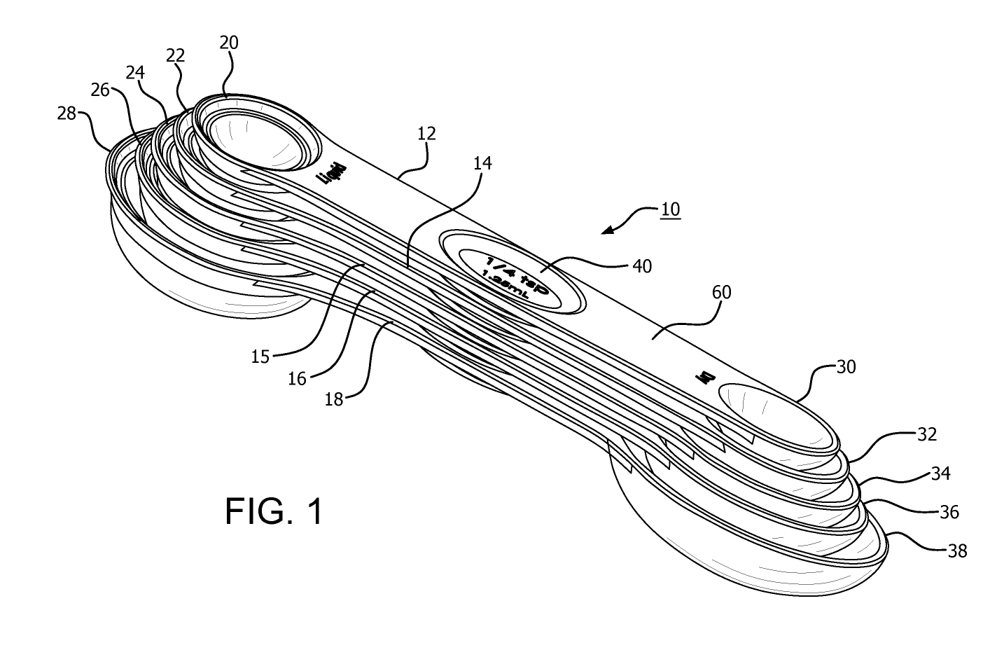

FIG. 1 is a perspective view showing a set 10 of wet/dry measurement spoons, 12, 14, 15, 16 and 18, each with different measurement capabilities. The spoons are releasably fastened together to make a compact, easily-stored set.

Each of the wet/dry spoons has a liquid measurement end 20, 22, 24, 26, or 28, and a dry measurement end 30, 32, 34, 36 and 38, respectively. Each spoon has a logo section 40 in the center of the handle 60 extending between the ends of the spoons. The logo section 40 lists the volumes of the wet and dry measurements which can be made with that particular spoon.

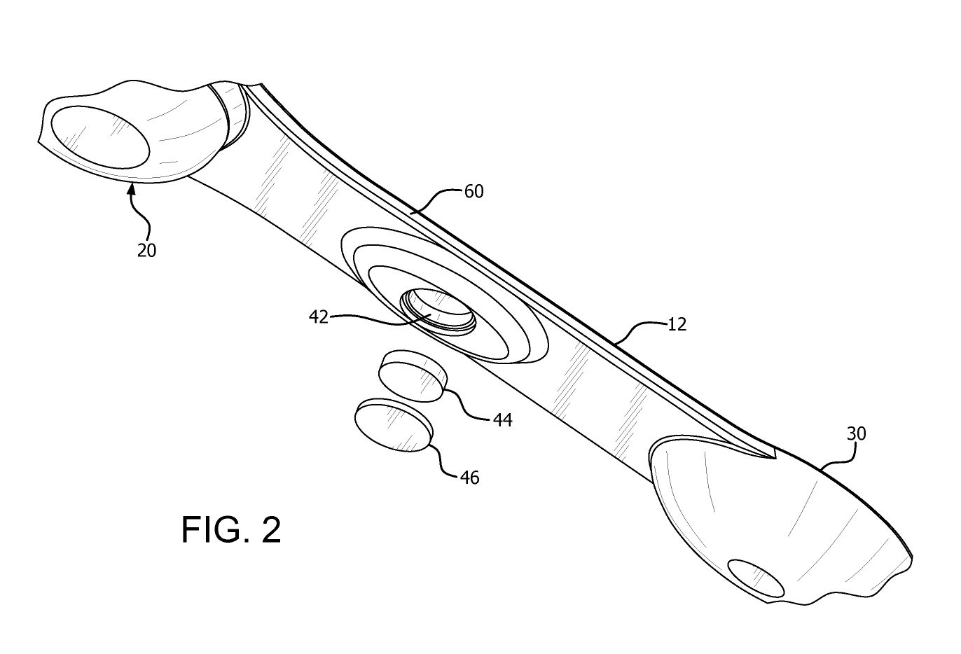

FIG. 2 shows the underside of the spoon 12 with a disc-shaped neodymium magnet 44. The magnet fits into a hole 42 in the underside of the spoon handle, and a plastic disc 46 covers the magnet.

Each spoon in a set has such a magnet construction, and the magnets act with one another to hold the spoons together to form the set.

Other means can be used to cause the spoons to be fastenable together, such as snap-acting plastic engagement structures, which are well-known in the art.

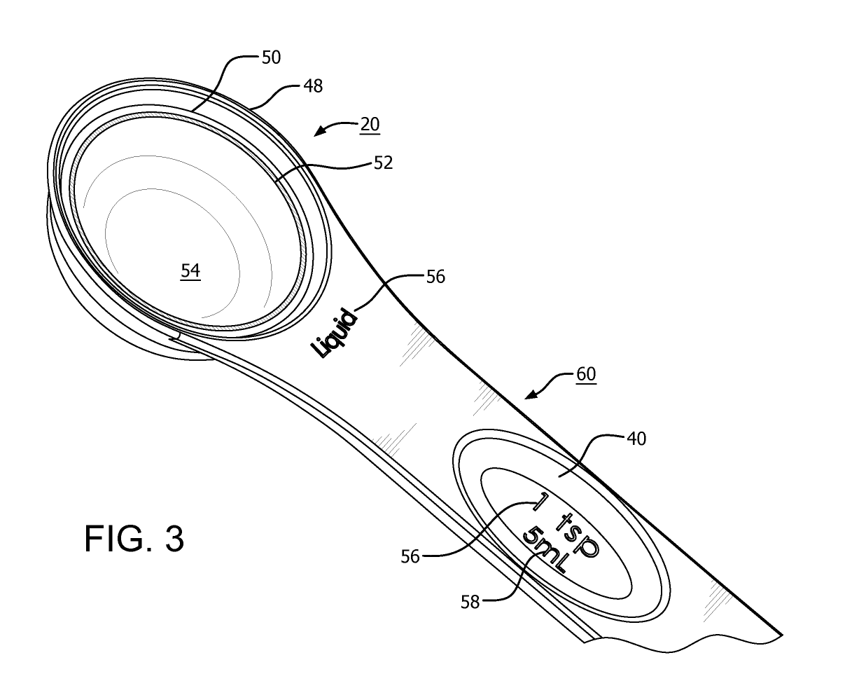

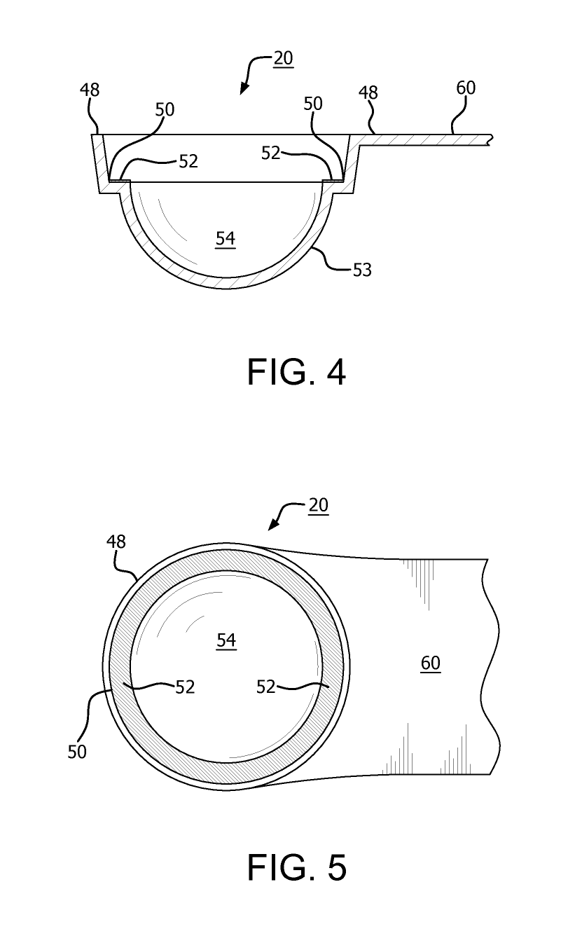

FIGS. 3, 4 and 5 show the liquid measurement spoon construction of the present invention. The liquid measurement spoon 20 includes a bowl 53 (FIG. 4) with an interior cavity 54. At the level in the bowl at which the proper measurement is indicated, an annular ledge 52 extends outwardly to an edge 50 where an upstanding flange 48 encircles the bowl.

When one looks down at the measurement spoon 20, as it is shown in FIG. 5 as well as FIG. 3, the ledge 52 is easily visible. Thus, if the liquid is poured into the bowl 54, it will be relatively easy to look down upon the measurement spoon to see whether the ledge 52 is covered.

In accordance with another feature of the invention, this capability is enhanced by giving the ledge 52 an appearance which contrasts with the appearance of the remainder of this spoon. For example, if the spoon body is made of dark plastic, the ledge 52 can be made white so as to contrast dark against light and make the ledge more easily visible.

If, despite the best efforts of the user, the liquid rises above the level of the ledge 52, it still is unlikely to spill out of the spoon because of the high rim 48 around the outside of the ledge.

The spoons are preferably molded from suitable food-grade, dishwasher-safe plastics which are well-known in the art.

Preferably, the ledge 52 is made by inserting a decal into the tool between separate molding cycles during the molding process.

Referring to FIG. 3, the logo section 40 indicates at 56 that the dry measurement end of the spoon measures one teaspoon, and the liquid measurement 58 provides a measurement of five milliliters.

A legend is formed on the spoon handle near the end 20 of the spoon at 56 where it is indicated that liquid should be measured at that end of the spoon.

As it can be seen from the foregoing, a liquid measurement spoon, a liquid/dry measurement combination spoon, and a set of such spoons are provided in which the liquid is very easy to measure without spilling, simply by looking down on the measurement spoon rather than having to scrutinize the spoon from the side or from another awkward angle.

The above description of the invention is intended to be illustrative and not limiting. Various changes or modifications in the embodiments described may occur to those skilled in the art. These can be made without departing from the spirit or scope of the invention.

What is claimed is:

1. A spoon comprising:
an elongated spoon body member having first and second opposed ends;
at the first of said ends a dry measurement container of a predetermined capacity; and
at the second of said ends, a liquid measurement container having a wall forming a bowl, and a ledge around the upper edge of said bowl forming a surface facing upwardly from the upper edge of said wall.

2. A spoon as in claim 1 in which said surface is contrasting in color with the remainder of said bowl to indicate the line to fill to for achieving the desired liquid measurement.

3. A spoon as in claim 1 with a permanent magnet buried in said spoon body member.

4. A spoon set comprising a plurality of spoons as in claim 1 with varying measurement capacities and releasably joined together in a set.

5. A set as in claim 4 in which each of said spoons in said set has a permanent magnet in said body member to releasably hold said spoons together in a set by interacting with the magnets in adjacent ones of said spoons.

6. A liquid measurement spoon having
a handle having two ends,
a bowl located at one of said ends, said bowl having a bottom and side wall and an upper edge, and a ledge at said upper edge with a further extension upwardly from the outer circumference of said ledge,
said ledge being located at a position in which it indicates that a pre-determined volume of liquid is contained in said bowl below said ledge, and
said ledge being easily visible from above said spoon.

7. A spoon as in claim 6 in which said bowl and said ledge are visually contrasting with one another to facilitate detecting the position of the upper surface of a liquid in said bowl relative to said ledge.

8. A spoon as in claim 7 in which said bowl and said handle are molded plastic and said ledge has a decal to make it contrasting said decal being applied during the molding process.

9. A spoon as in claim 8 in which said plastic is opaque and of a dark color and said decal is of a light color.
